(19) United States
(12) Patent Application Publication
(10) Pub. No.: US 2011/0141899 A1
(43) Pub. Date: Jun. 16, 2011

(54) NETWORK ACCESS APPARATUS AND METHOD FOR MONITORING AND CONTROLLING TRAFFIC USING OPERATION, ADMINISTRATION, AND MAINTENANCE (OAM) PACKET IN INTERNET PROTOCOL (IP) NETWORK

(75) Inventor: Byung Ho YAE, Daejeon (KR)

(73) Assignee: Electronics and Telecommunications Research Institute, Daejeon (KR)

(21) Appl. No.: 12/963,564

(22) Filed: Dec. 8, 2010

(30) Foreign Application Priority Data
Dec. 15, 2009 (KR) 10-2009-0124646

(51) Int. Cl. H04L 12/26

(52) U.S. Cl. 370/236.2

(57) ABSTRACT

Provided is a network access apparatus that is configured in an Internet Protocol (IP) network to thereby connect a user equipment and a service providing apparatus to the IP network. The network access apparatus may include: a packet receiver to receive a packet transferred from a user equipment and a service providing apparatus; an Operation, Administration, and Maintenance (OAM) packet processor to generate an OAM packet in the case of a source access apparatus, and to receive an OAM in the case of a destination access apparatus, and to contain load and traffic information of the destination access apparatus and generate the OAM packet in response to the source access apparatus; a traffic manager to measure and control traffic; and a packet transmitter to transmit, to a destination, a packet output from the OAM packet processor and the traffic manager.

### CROSS-REFERENCE TO RELATED APPLICATION

This application claims the benefit of Korean Patent Application No. 10-2009-0124646, filed on Dec. 15, 2009, in the Korean Intellectual Property Office, the disclosure of which is incorporated herein by reference.

### BACKGROUND

1. Field of the Invention

The present invention relates to a network access apparatus and method for monitoring and controlling traffic using an Operation, Administration, and Maintenance (OAM) packet in an Internet Protocol (IP) network. More particularly, the present invention relates to a network access apparatus and method that may share load and traffic information of all the destination nodes and load information of slave nodes of a destination end using an OAM packet.

2. Description of the Related Art

To determine a load state and control traffic within an Internet Protocol (IP) network, a conventional traffic management method has been performed by installing and operating, in a network, a separate traffic measuring and controlling apparatus, or by transferring, to an external management system, load information measured by a node apparatus within the network to determine the load state through analysis and to request a node within the network for traffic control depending on an analysis result. In this case, use of a separate apparatus has increased costs and had insufficient capabilities of coping with abnormal traffic occurring in the network due to a difficulty of real-time processing.

In addition, the conventional traffic management method may not quickly cope with malicious attacks such as a Distributed Denial of Service (DDoS) attack frequently occurring in an IP network. Currently, apparatuses are installed to prevent or defend such malicious traffic attacks. However, since an attacker generally uses IP spoofing or continuously generates a new type of traffic, it is very difficult to identify the malicious attack and thus there are some constraints on coping with the malicious attack. In addition, when attack agents are distributed over all the networks instead of being centralized in one network, it may become serious issue.

The above problems may occur since there is no method that enables all the node apparatuses to share traffic information in an IP network. Accordingly, there is required a function and method that may analyze a traffic pattern of attack traffic and thereby determine an abnormal state in real time until a countermeasure is performed, and enables node apparatuses to share information and thereby may control traffic. For this, there is a desire for a network processor that may classify a traffic type through a high speed Deep Packet Inspection (DPI) and provide a large capacity processing throughput.

### SUMMARY

An aspect of the present invention provides a network access apparatus and method that may monitor and control traffic using an Operation, Administration, and Maintenance (OAM) packet in an Internet Protocol (IP) network.

Another aspect of the present invention also provides a network access apparatus and method that may share load and traffic information of all the destination end nodes and load information of slave devices of each destination end node using an OAM packet.

Another aspect of the present invention also provides a network access apparatus and method that enables a source node transmitting an OAM packet to control traffic, which is transmitted to a destination node and slave nodes of the destination node, depending on a load state of each of the destination node and the slave nodes.

Another aspect of the present invention also provides a network access apparatus and method that may transfer, to a management system, a response result of an OAM packet from a destination node, CPU load, input/output traffic from a network, a transfer delay, and load information of a slave device and thereby enables the management system to analyze the entire network state.

Another aspect of the present invention also provides a network access apparatus and method that enables an operator to change a control target traffic type and a setting of a reference value for each load class so that a source node may flexibly cope with various types of traffic.

Another aspect of the present invention also provides a network access apparatus and method that enables an operator to arbitrarily set a destination end node that is an operation target, and an operation interval in order to prevent excessive occurrence of traffic in a network when an OAM packet operates.

According to an aspect of the present invention, there is provided a network access apparatus, including: a packet receiver to receive a packet transferred from a user equipment and a service providing apparatus; an OAM packet processor to generate an OAM packet in the case of a source access apparatus, and to receive an OAM in the case of a destination access apparatus, and to contain load and traffic information of the destination access apparatus and generate the OAM packet in response to the source access apparatus; a traffic manager to measure and control traffic; and a packet transmitter to transmit, to a destination, a packet output from the OAM packet processor and the traffic manager.

In the case of the source access apparatus, the OAM packet processor may generate the OAM packet containing timestamp information of the source access apparatus, and may transmit the OAM packet to the destination access apparatus via the packet transmitter.

In the case of the destination access apparatus, the OAM packet processor may include, in the OAM packet, timestamp information of the destination access apparatus, Central Processing Unit (CPU) load, traffic information, and load state information of slave devices, and may transmit the OAM packet to the source access apparatus via the packet transmitter.

In the case of the source access apparatus, the OAM packet processor may receive the timestamp information from the destination access apparatus to calculate a transfer delay time, to store the CPU load, the traffic information, and the load state information of the slave devices, and to transfer information to a management system.

In the case of the source access apparatus, the OAM packet processor may receive, from the management system, an OAM transmission interval, a reference value for each load class, and a change request for control target traffic type information, and may update the same in a management table.

In the case of the source access apparatus, the traffic manager may cut off traffic with respect to control target traffic for each load class by referring to load state information of slave devices of the destination access apparatus.

In the case of the destination access apparatus, the traffic manager may measure traffic per unit time with respect to slave devices of the destination access apparatus, and may calculate an occupancy rate based on an assigned maximum bandwidth.

The traffic manager may analyze a packet in a destination node to thereby determine a load state of slave devices of the destination node based on an occupancy rate with respect to a bandwidth assigned to a corresponding slave device.

The traffic manager may perform a traffic control process with respect to a corresponding class by reading control target traffic type information for each load class with respect to a slave device, and then may shift to a packet reception state for subsequent processing.

According to another aspect of the present invention, there is provided a method of monitoring and controlling traffic, including: driving, by a network access apparatus, an operation timer when a system operates and thereby a monitoring function starts; reading, by the network access apparatus, destination address information and time information of a source node and then generating an OAM packet; requesting, by the network access apparatus, a destination node for a transmission of an OAM packet; reading, by the network access apparatus, reading CPU load and traffic information of the destination node and calculating a transfer delay time to determine a load state of a slave device of the destination node when the OAM packet is received from the destination; and reading, by the network access apparatus, corresponding information when the load state exists to store the load state in a load state table with respect to the slave device.

The method may further include repeating, by the network access apparatus, the same process with respect to a subsequent destination node and then registering a timer for a subsequent interval and shifting to a reception standby state when the subsequent destination node exists.

According to still another aspect of the present invention, there is provided a method of monitoring and controlling traffic, including: shifting, by a network access apparatus, to a reception standby state for receiving an OAM packet from a source node when a system operates and thereby a monitoring function starts; reading, by the network access apparatus, destination address information within an OAM packet to verify whether a corresponding address corresponds to an address of the network access apparatus when the OAM packet is received from the source node; reading, by the network access apparatus, CPU load of the destination node, traffic information, timestamp information, and load information of slave devices of the destination node and then generating an OAM packet to respond to the source node when the destination node address information matches address information of the network access apparatus; and shifting, by the network access apparatus, to a reception standby state for receiving a subsequent OAM packet.

The method may further include bypassing, by the network access apparatus, the destination address information for a normal packet processing and shifting to a reception standby state for a subsequent receiving operation when the destination address information does not match the address information of the network access apparatus.

According to a further another aspect of the present invention, there is provided a method of monitoring and controlling traffic, including: reading, by a network access apparatus, destination node information and load information of slave devices of the destination node to verify whether to control load of slave devices of a destination node when a packet is received in a reception standby state; verifying, by the network access apparatus, whether a packet destination address matches a slave device address when traffic is in a controllable state depending on the verification result; and reading, by the network access apparatus, control target traffic type information for each load class and controlling traffic with respect to a corresponding traffic class when the packet destination address matches the slave device address, the control target traffic type information being determined based on the load class.

The method may further include performing, by the network access apparatus, normal packet processing and shifting to a reception standby state when the packet destination address does not match the slave device address.

### EFFECT

According to embodiments of the present invention, there may be provided a network access apparatus and method that may quickly share load and traffic information of all the destination end nodes and load information of slave devices of each destination end node using an Operation, Administration, and Maintenance (OAM) packet.

Also, according to embodiments of the present invention, there may be provided a network access apparatus and method that enables a source node transmitting an OAM packet to control traffic, which is transmitted to a destination node and slave nodes of the destination node, depending on a load state of each of the destination node and the slave nodes. Accordingly, it is possible to guarantee a static operation of a network and a normal operation of an end apparatus through a control and prevention of traffic flowing into a network.

Also, according to embodiments of the present invention, there may be provided a network access apparatus and method that may transfer, to a management system, a response result of an OAM packet from a destination node, CPU load, input/output traffic from a network, a transfer delay, and load information of a slave device and thereby enables the management system to analyze the entire network state. Accordingly, an operator may take necessary countermeasures depending on results.

Also, according to embodiments of the present invention, there may be provided a network access apparatus and method that enables an operator to change a control target traffic type and a setting of a reference value for each load class so that a source node may flexibly cope with various types of traffic.

Also, according to embodiments of the present invention, there may be provided a network access apparatus and method that enables an operator to arbitrarily set a destination end node that is an operation target, and an operation interval in order to prevent excessive occurrence of traffic in a network when an OAM packet operates.

Also, according to embodiments of the present invention, it is possible to detect in advance a traffic concentration to a particular node and apparatus, and to control traffic. Accordingly, it is possible to effectively cope with a malicious traffic attack such as a Distributed Denial of Service (DDoS) attack.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a network including a wideband Internet Protocol (IP) network, an edge node, a slave user, and service providers according to an embodiment of the present invention;

FIG. 2 is a block diagram to describe a process of transmitting and receiving, by an edge node apparatus, a packet, and processing an Operation, Administration, and Maintenance (OAM) packet according to an embodiment of the present invention;

FIG. 3 is a diagram illustrating a format of an OAM packet to perform a monitoring function according to an embodiment of the present invention;

FIG. 4 is a diagram to describe a configuration between a source node and a destination node, and a processing procedure according to an embodiment of the present invention;

FIG. 5 is a table to describe a configuration of monitoring function control and capability information with respect to a destination node according to an embodiment of the present invention;

FIG. 6 is a table illustrating load state information with respect to salve devices for each destination node, which is managed by a source node, according to an embodiment of the present invention;

FIG. 7 is a diagram illustrating a data format for managing a load class criterion and a control target traffic type with respect to slave devices of a destination node, which is managed by a source node, according to an embodiment of the present invention;

FIGS. 8A and 8B are flowcharts illustrating a monitoring function, periodically performed by a source node, according to an embodiment of the present invention;

FIG. 9 is a flowchart illustrating a process of receiving, by a destination node, an OAM packet from a source node and then responding to the OAM packet by including load information according to an embodiment of the present invention; and

FIG. 10 is a flowchart illustrating a process of processing, by a source node, a traffic control when load occurs in slave devices of a destination node according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, a network access apparatus and method of monitoring and controlling traffic using an Operation, Administration, and Maintenance (OAM) packet in an Internet Protocol (IP) network according to embodiments of the present invention will be described with reference to the accompanying drawings.

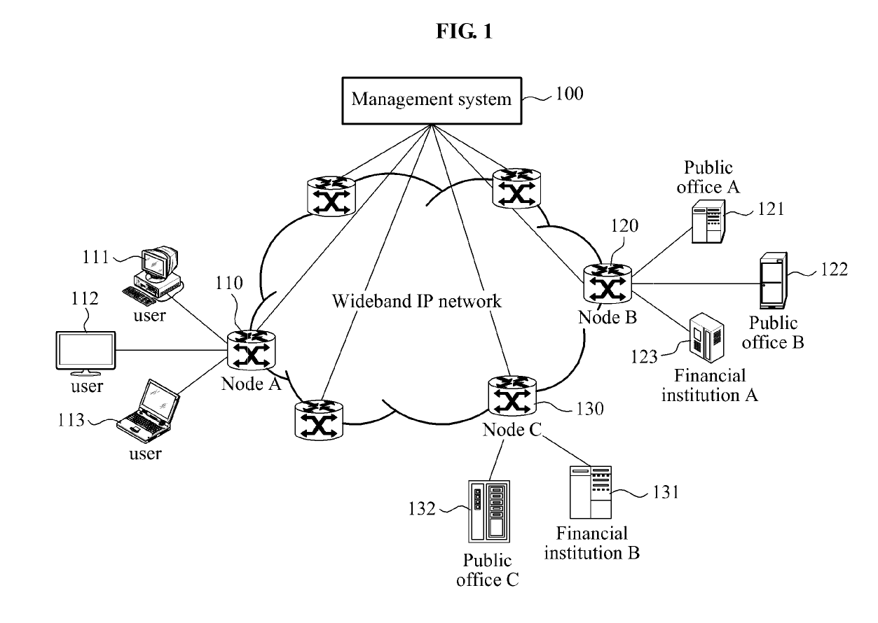

FIG. 1 is a diagram illustrating a network including a wideband IP network, an edge node, a slave user, and service providers according to an embodiment of the present invention.

Referring to FIG. 1, the wideband IP network according to an embodiment of the present invention denotes a network including all the Internet Protocol version 4 (IPv4) and IPv6 address systems. A node A 110, a node B 120, and a node C 130 correspond to edge devices, and may receive users 111, 112, and 113, or may receive a public office A 121, a public office B 122, a public office C 132, a financial institution A 123, and a financial institution B 131 that function as service providers. In this structure, when users desire to receive a service, the users may request a service providing apparatus for the service along a path including apparatuses included in the IP network, and may receive a result in response to the request.

According to an embodiment of the present invention, in this network structure, there is provided a method that may periodically monitor a transfer delay occurring in a path to a destination and a capability of a destination device using an OAM packet by setting, as a source, the node A 110 that is an edge apparatus receiving the users 111, 112, and 113, and by setting, as destinations, the node B 120 and the node C 130 receiving the service providers.

Also, according to an embodiment of the present invention, there is provided a method that may achieve a network stability and may also protect service providing apparatuses received in a destination node by controlling, by a source node, traffic according to a service control standard that is pre-defined depending on a load state of a destination.

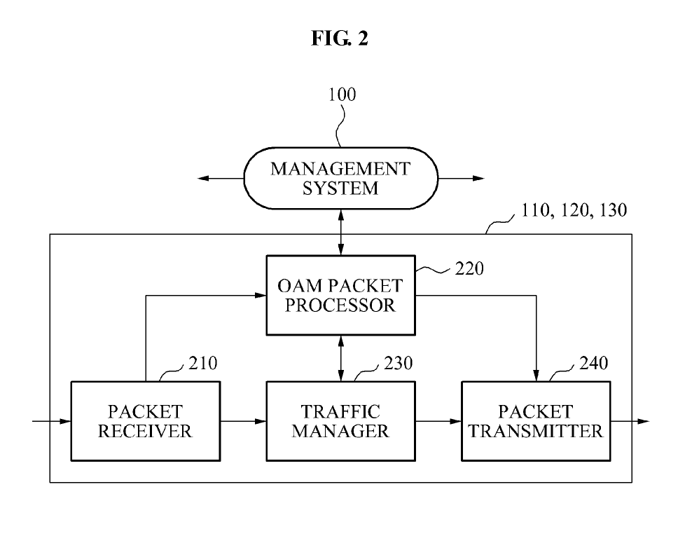

FIG. 2 is a block diagram to describe a process of transmitting and receiving, by an edge node apparatus, a packet, and processing an OAM packet according to an embodiment of the present invention.

Referring to FIGS. 1 and 2, the network access apparatus corresponding to an edge node, for example, the node A 110, the node B 120, or the node C 130 of FIG. 1 may include a packet receiver 210, an OAM packet processor 220, a traffic manager 230, and a packet transmitter 240.

The packet receiver 210 may receive a packet transferred from a user equipment and a service providing apparatus. For example, the user equipment may correspond to the users 111, 112, and 113 of FIG. 1, and the service providing apparatus may correspond to the public office A 121, the public office B 122, the public office C 132, the financial institution A 123, and the financial institution B 131.

In the case of a source access apparatus, the OAM packet processor 220 may generate an OAM packet. In the case of a destination access apparatus, the OAM packet processor 220 may receive an OAM packet, and may contain load and traffic information of the destination access apparatus in the OAM packet and thereby generate the OAM packet in response to the source access apparatus.

The traffic manager 230 may measure and manage traffic.

The packet transmitter 240 may transmit, to a destination, a packet output from the OAM packet processor 220.

A management system 100 may enable an operator to set an operation of a capability monitoring function and traffic control information using the OAM packet.

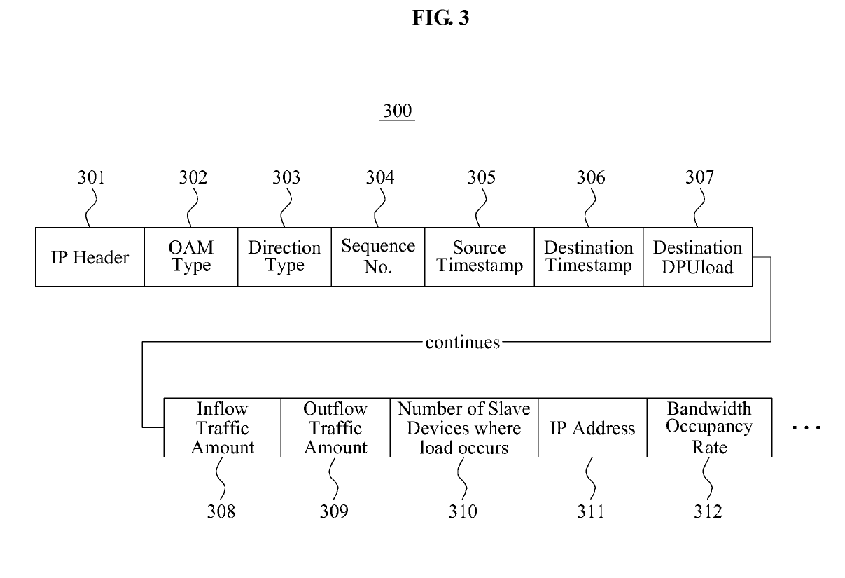

FIG. 3 is a diagram illustrating a format of an OAM packet 300 to perform a monitoring function according to an embodiment of the present invention.

Referring to FIG. 3, the OAM packet 300 may include information associated with an IP header 301, an OAM type 302 for classifying an OAM function, a direction type 303 for determining whether the OAM packet 300 is transferred from a source node to a destination node, or from the destination node to the source node, a sequence No. 304 for managing a sequence in a transmission and reception process, a source timestamp 305 for containing time information associated with a point in time when the OAM packet 300 is transmitted from the source node, a destination timestamp 306 that is time information associated with a point in time when the destination node receives the OAM packet 300, a destination CPU load 307 indicating a load state of a processor of the destination node, an inflow traffic amount 308 from a network and an outflow traffic amount from the network 309 per unit time of the destination node, a number 310 of slave devices where load occurs among slave nodes of the destination node, an IP address 311 of a first device, and a bandwidth occupancy rate 312 of the first device. The number of slave devices where the load occurs may be set to be an appropriate value within a size of the IP packet 300 and thereby be operated.

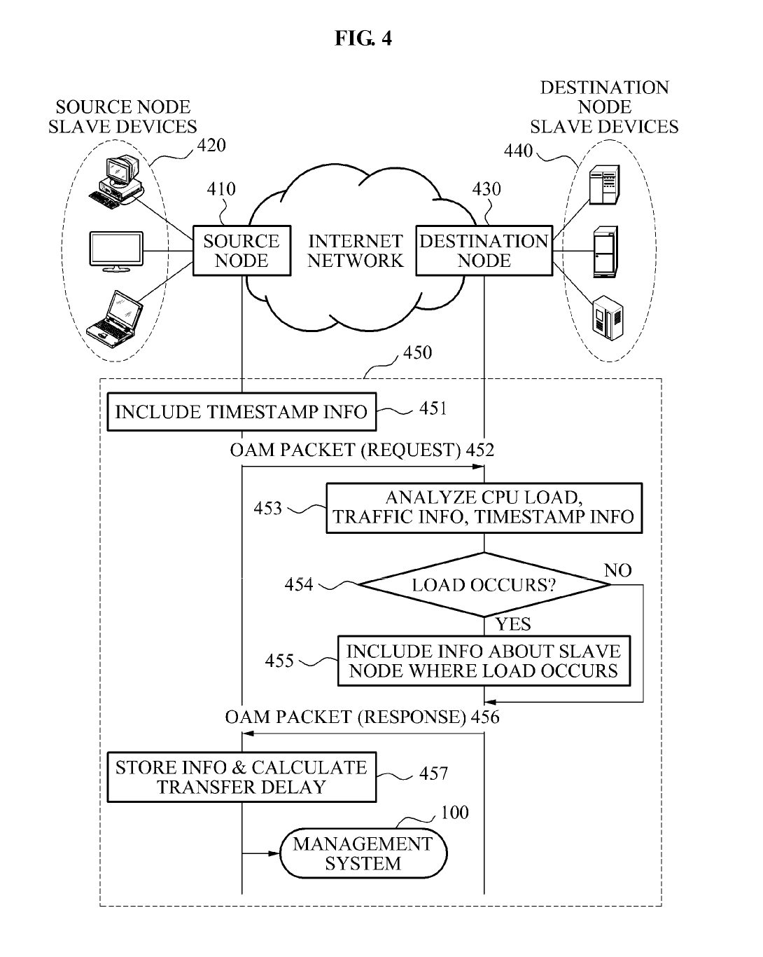

FIG. 4 is a diagram to describe a configuration between a source node 410 and a destination node 430, and a processing procedure according to an embodiment of the present invention.

Referring to FIG. 4, an IP network structure according to an embodiment of the present invention may include the source node 410 and source node slave devices 420 subordinate to the source node 410, the destination node 430, and destination node slave devices 440 subordinate to the destination node 430.

When a monitoring function is driven, the source node 410 may contain timestamp information in an OAM packet (451), and then transmit the OAM packet to the destination node 430 (452). The destination node 430 may analyze CPU load used to determine a load state, inflow and outflow traffic information from a network, and the timestamp information (453), and may determine whether load occurs in a slave device (454). The destination node 430 may contain, in the OAM packet, information associated with the slave node where the occurs (455), and may transmit the OAM packet to the source node 410 as a response (456).

The source node 410 may store information of the received OAM packet and calculate a transfer delay and then transfer the OAM packet to a management system 100 (457). Through this, a single processing process 450 may be completed and be repeated at predetermined intervals.

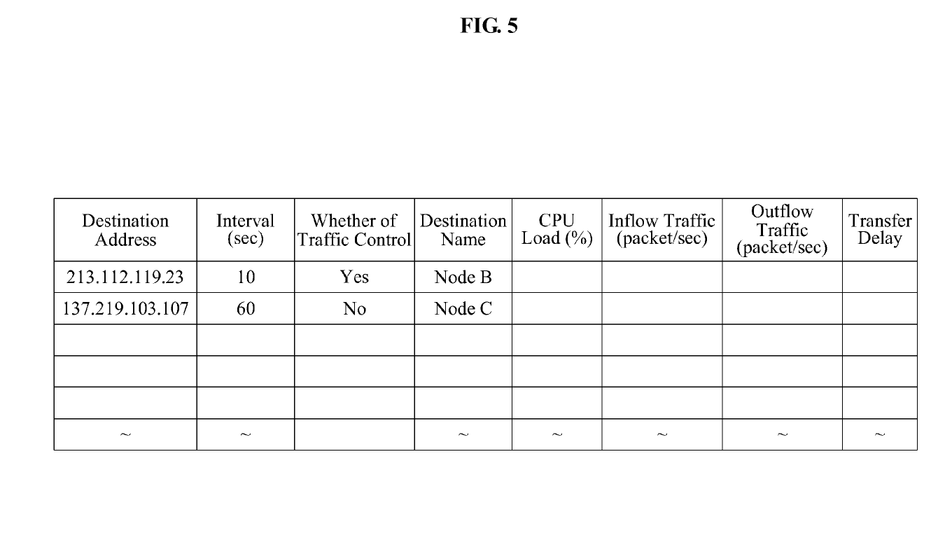

FIG. 5 is a table to describe a configuration of monitoring function control and capability information with respect to a destination node, which is managed by a source node, according to an embodiment of the present invention.

Referring to FIG. 5, the monitoring function control and capability information may include a destination address that is an address of a destination node corresponding to a monitoring target, an interval, whether of a traffic control at the source node depending on a load state of a slave device, a destination name assigned to make it easy to identify a corresponding destination node, CPU load information of the destination node, inflow traffic information from a network of the destination node, outflow traffic information to the network of the destination node, and a transfer delay from the source node to the destination node.

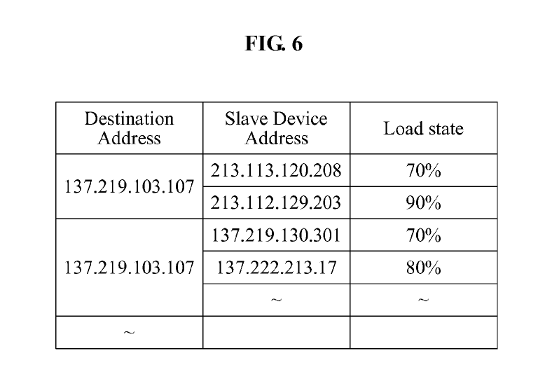

FIG. 6 is a table illustrating load state information with respect to salve devices for each destination node, which is managed by a source node, according to an embodiment of the present invention.

Referring to FIG. 6, the load state information may include a destination address of each destination node, a slave device address of each of slave devices where load occurs, and a load state of each slave device. The traffic control may be performed by the source node depending on the load state, by employing the defined slave device address.

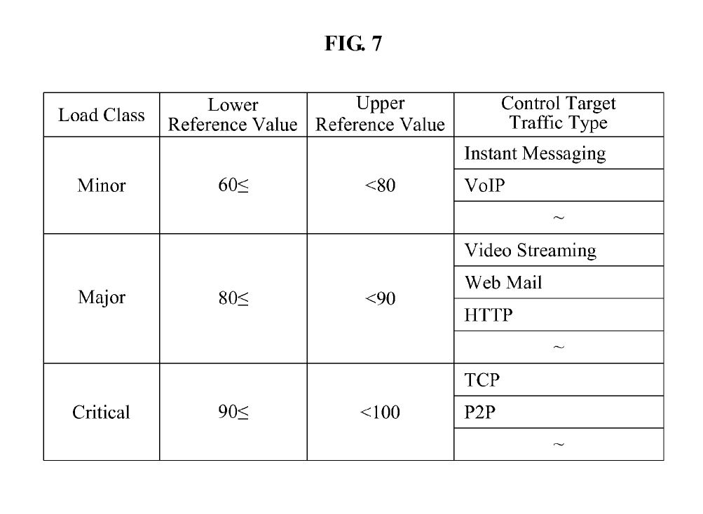

FIG. 7 is a diagram illustrating a data format for managing a load class criterion and a control target traffic type with respect to slave devices of a destination node, which is managed by a source node, according to an embodiment of the present invention.

Referring to FIG. 7, the data format may include information associated with a load class, an upper value and a lower value of a decision reference value for each load class, and a control target traffic type. Since traffic may be flexibly variable, the information may be configured to be modified by an operator.

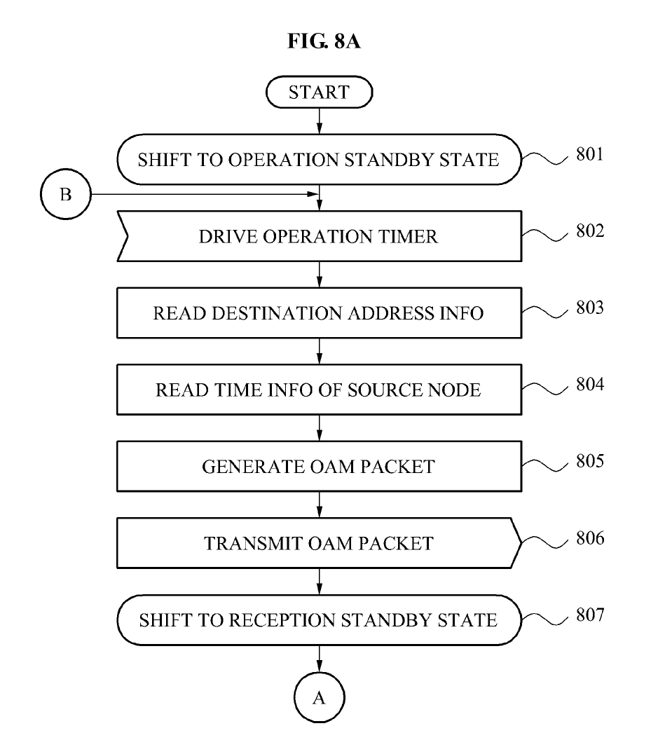

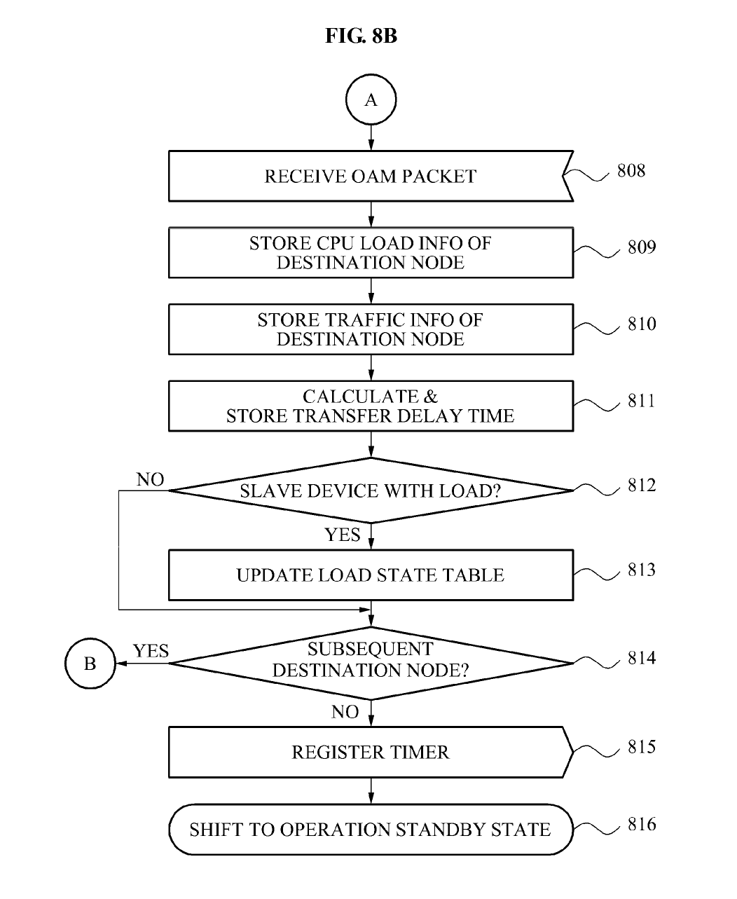

FIGS. 8A and 8B are flowcharts illustrating a monitoring function, periodically performed by a source node, according to an embodiment of the present invention.

Referring to FIGS. 8A and 8B, when a management system operates and thereby the monitoring function starts, a timer may be registered and the network access apparatus may shift to an operation standby state in operation 801. When an operation timer operates in operation 802, the network access apparatus may read defined destination address information in operation 803, read time information of the source node in operation 804, and then generate an OAM packet in operation 805. The network access apparatus may request a destination node for a packet transmission in operation 806, and may shift to a reception standby state for receiving a response from the destination node in operation 807.

When the OAM packet is received from the destination node in operation 808, the network access apparatus may store CPU load information of the destination node in operation 809, store traffic information of the destination node in operation 810, and then read the CPU load information and the traffic information and calculate and store a transfer delay time in operation 811.

In operation 812, the network access apparatus may determine a load state of a salve device of the destination node. When load occurs in the slave node, the network access apparatus may update a load state table with respect to the slave node by storing corresponding management information in the load state table in operation 813, and then may verify whether a subsequent destination node exists in operation 814. When the subsequent destination node exists, the network access apparatus may repeat the same process with respect to the subsequent destination node. When the subsequent destination does not exist, the network access apparatus may register a timer for a subsequent interface in operation 815 and shift to an operation standby state in operation 816.

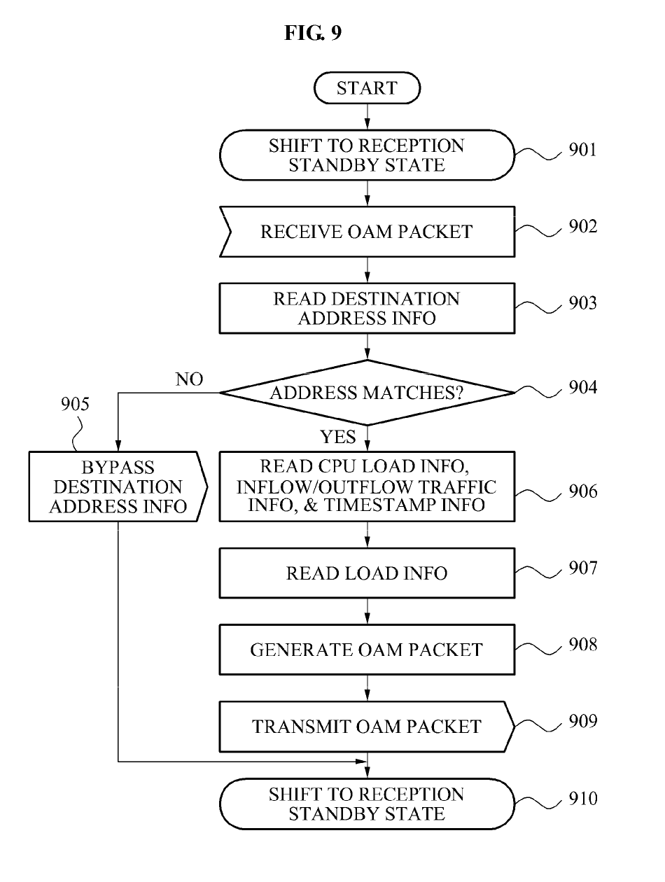

FIG. 9 is a flowchart illustrating a process of receiving, by a destination node, an OAM packet from a source node and then responding to the OAM packet by including load information according to an embodiment of the present invention.

When a management system operates, a network access apparatus may shift to a reception standby state for receiving the OAM packet from the source node in operation 901. When the OAM packet is received in operation 902, the network access apparatus may read destination address information within the OAM packet in operation 903, and may verify whether a destination address matches its address in operation 904.

When the address information does not match, the network access apparatus may bypass the destination address information for normal packet processing in operation 905 and then shift to a reception standby state for a subsequent reception in operation 910.

When the address information matches, the network access apparatus may read CPU load information of the destination node, inflow traffic information from a network, outflow traffic information to the network, and timestamp information in operation 906, and then read load information with respect to slave devices of the destination node in operation 907.

The network access apparatus may generate the OAM packet in operation 908, and then transmit the OAM packet to the source node as a response in operation 909, and then shift to the reception standby state for receiving a subsequent OAM packet in operation 910. In this instance, a load state of each of slave nodes of the destination node may be determined based on an occupancy rate with respect to a bandwidth assigned to a corresponding slave node by analyzing the OAM packet in the destination node.

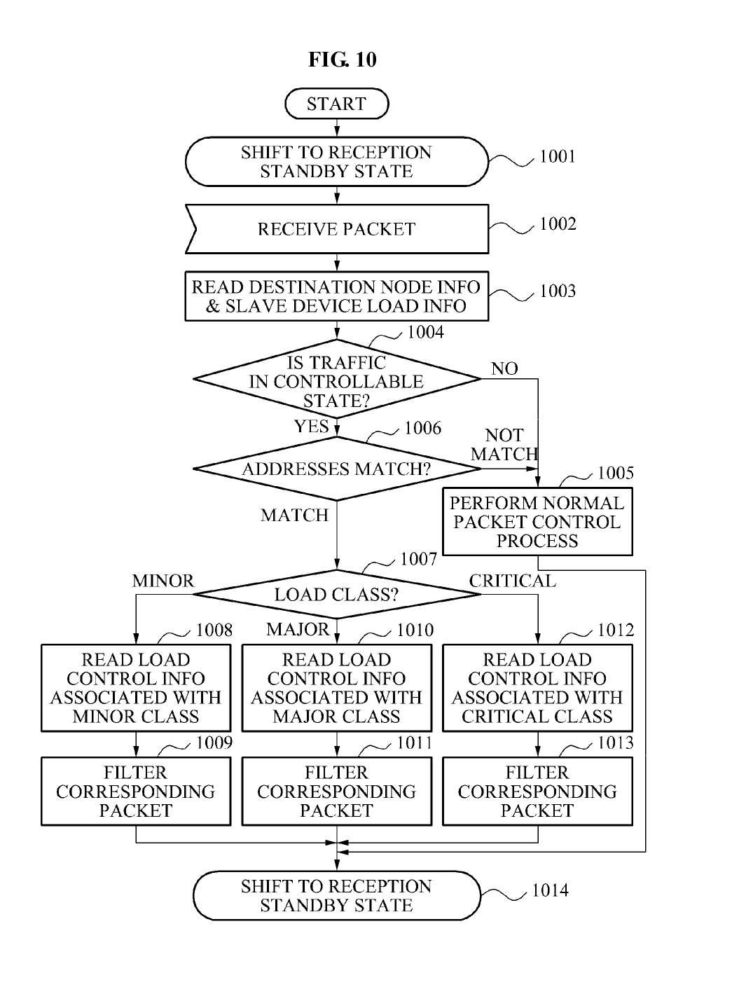

FIG. 10 is a flowchart illustrating a process of processing, by a source node, a traffic control when load occurs in slave devices of a destination node according to an embodiment of the present invention.

Referring to FIG. 10, when a management system operates, a network access apparatus may shift to a reception standby state in operation 1001. When a packet is received in operation 1002, the network access apparatus may read destination node information defined in FIGS. 5 and 6, and load information with respect to slave devices in operation 1003, and then verify whether to control a load of slave nodes of the destination node in operation 1004. When traffic is not in a controllable state, the network access apparatus may perform a normal packet control process in operation 1005 and shift to a reception standby state for subsequent processing in operation 1014.

When the traffic is in the controllable state, the network access apparatus may verify whether a packet destination address matches a control target slave device address in operation 1006. When the address information does not match, the network access apparatus may perform the normal packet control process in operation 1005 and then shift to the reception standby state in operation 1014.

Conversely, when the address information matches, the network access apparatus may determine a load class of a corresponding slave device in operation 1007.

When the determined load class corresponds to a minor class, the network access apparatus may read load control information associated with the minor class in operation 1008, and may filter a corresponding packet for traffic control according to the minor class in operation 1009.

When the determined load class corresponds to a major class, the network access apparatus may read load control information associated with the major class in operation 1010, and may filter a corresponding packet for traffic control according to the major class in operation 1011.

When the determined load class corresponds to a critical class, the network access apparatus may read load control information associated with the critical class in operation 1012, and may filter a corresponding packet for traffic control according to the critical class in operation 1013.

A method of controlling traffic according to embodiments of the present invention may read control target traffic type information for each load class and thereby perform a traffic control process with respect to a corresponding class.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A network access apparatus, comprising:
a packet receiver to receive a packet transferred from a user equipment and a service providing apparatus;
an Operation, Administration, and Maintenance (OAM) packet processor to generate an OAM packet in the case of a source access apparatus, and to receive an OAM in the case of a destination access apparatus, and to contain load and traffic information of the destination access apparatus and generate the OAM packet in response to the source access apparatus;
a traffic manager to measure and control traffic; and
a packet transmitter to transmit, to a destination, a packet output from the OAM packet processor and the traffic manager.

2. The network access apparatus of claim 1, wherein:
in the case of the source access apparatus, the OAM packet processor generates the OAM packet containing timestamp information of the source access apparatus, and transmits the OAM packet to the destination access apparatus via the packet transmitter.

3. The network access apparatus of claim 1, wherein:
in the case of the destination access apparatus, the OAM packet processor includes, in the OAM packet, timestamp information of the destination access apparatus, Central Processing Unit (CPU) load, traffic information, and load state information of slave devices, and transmits the OAM packet to the source access apparatus via the packet transmitter.

4. The network access apparatus of claim 3, wherein:
in the case of the source access apparatus, the OAM packet processor receives the timestamp information from the destination access apparatus to calculate a transfer delay time, to store the CPU load, the traffic information, and the load state information of the slave devices, and to transfer information to a management system.

5. The network access apparatus of claim 4, wherein:
in the case of the source access apparatus, the OAM packet processor receives, from the management system, an OAM transmission interval, a reference value for each load class, and a change request for control target traffic type information, and updates the same in a management table.

6. The network access apparatus of claim 1, wherein:
in the case of the source access apparatus, the traffic manager cuts off traffic with respect to control target traffic for each load class by referring to load state information of slave devices of the destination access apparatus.

7. The network access apparatus of claim 1, wherein:
in the case of the destination access apparatus, the traffic manager measures traffic per unit time with respect to slave devices of the destination access apparatus, and calculates an occupancy rate based on an assigned maximum bandwidth.

8. The network access apparatus of claim 1, wherein:
the traffic manager analyzes a packet in a destination node to thereby determine a load state of slave devices of the destination node based on an occupancy rate with respect to a bandwidth assigned to a corresponding slave device.

9. The network access apparatus of claim 1, wherein:
the traffic manager performs a traffic control process with respect to a corresponding class by reading control target traffic type information for each load class with respect to a slave device, and then shifts to a packet reception state for subsequent processing.

10. A method of monitoring and controlling traffic, comprising:
driving, by a network access apparatus, an operation timer when a system operates and thereby a monitoring function starts;
reading, by the network access apparatus, destination address information and time information of a source node and then generating an OAM packet;
requesting, by the network access apparatus, a destination node for a transmission of an OAM packet;
reading, by the network access apparatus, reading CPU load and traffic information of the destination node and calculating a transfer delay time to determine a load state of a slave device of the destination node when the OAM packet is received from the destination; and
reading, by the network access apparatus, corresponding information when the load state exists to store the load state in a load state table with respect to the slave device.

11. The method of claim 10, further comprising:
repeating, by the network access apparatus, the same process with respect to a subsequent destination node and then registering a timer for a subsequent interval and shifting to a reception standby state when the subsequent destination node exists.

12. A method of monitoring and controlling traffic, comprising:
shifting, by a network access apparatus, to a reception standby state for receiving an OAM packet from a source node when a system operates and thereby a monitoring function starts;
reading, by the network access apparatus, destination address information within an OAM packet to verify whether a corresponding address corresponds to an address of the network access apparatus when the OAM packet is received from the source node;
reading, by the network access apparatus, CPU load of the destination node, traffic information, timestamp information, and load information of slave devices of the destination node and then generating an OAM packet to respond to the source node when the destination node address information matches address information of the network access apparatus; and
shifting, by the network access apparatus, to a reception standby state for receiving a subsequent OAM packet.

13. The method of claim 12, further comprising:
bypassing, by the network access apparatus, the destination address information for a normal packet processing and shifting to a reception standby state for a subsequent receiving operation when the destination address information does not match the address information of the network access apparatus.

14. The method of claim 12, further comprising:
reading, by a network access apparatus, destination node information and load information of slave devices of the destination node to verify whether to control load of slave devices of a destination node when a packet is received in a reception standby state;
verifying, by the network access apparatus, whether a packet destination address matches a slave device address when traffic is in a controllable state depending on the verification result; and
reading, by the network access apparatus, control target traffic type information for each load class and controlling traffic with respect to a corresponding traffic class when the packet destination address matches the slave device address, the control target traffic type information being determined based on the load class.

15. The method of claim 14, further comprising:
performing, by the network access apparatus, normal packet processing and shifting to a reception standby state when the packet destination address does not match the slave device address.
